(19) United States
(12) Patent Application Publication
(10) Pub. No.: US 2013/0263019 A1
(43) Pub. Date: Oct. 3, 2013

(54) ANALYZING SOCIAL MEDIA

(71) Applicants: Maria G. CASTELLANOS, Sunnyvale, CA (US); Umeshwar Dayal, Satatoga, CA (US); Riddhiman Ghosh, Sunnyvale, CA (US); Meichun Hsu, Los Altos Hills, CA (US)

(72) Inventors: Maria G. CASTELLANOS, Sunnyvale, CA (US); Umeshwar Dayal, Satatoga, CA (US); Riddhiman Ghosh, Sunnyvale, CA (US); Meichun Hsu, Los Altos Hills, CA (US)

(21) Appl. No.: 13/436,541

(22) Filed: Mar. 30, 2012

(51) Int. Cl. G06F 3/01

(52) U.S. Cl. 715/753

(57) ABSTRACT

A system, method and a non-transitory computer readable medium comprising instructions for automated analysis of for analyzing social media, the method comprising a processor to acquire data as a snapshot or a continuous stream from one or more online sites via adapters. Storing data in a database, the database configured for rapid acquisition of data and rapid responses to queries from one or a plurality of users. Analyzing the data using one or a plurality of algorithms, the algorithms configured to distill insight at an attribute level, and presenting one or a plurality of graphical user interfaces on a user-configurable, and temporal-view adjustable dashboard, the dashboard configured to present one or more results of said one or a plurality of algorithms, said one or more results depicted through one or a plurality of paradigms of data visualization.

### BACKGROUND

The rapid proliferation of blogs, microblogs, review sites, social media networks and other Web 2.0 sites, has made it possible for people to publish their opinions more quickly, frequently, and with greater social repercussions than ever before. The ease with which people can express their thoughts and make them instantaneously available on these sites is a key reason behind this phenomenon. For most businesses, online opinions represent an invaluable source of information and consternation.

Many businesses have people dedicated to the task of reading what is posted online and extracting insight into what is being said about their products and services, or about their competitors' products and services. For these businesses, compiling and analyzing opinion may become critical to remaining competitive. However, with the increasing rate at which online opinions are being created, it becomes harder and harder to curate and analyze them manually and to take immediate, real-time action: for example, reacting to an issue expressed in a blog before its negative opinion spreads and impacts the product sales in the marketplace. This has fueled the emerging field known as opinion mining whose goal is to translate the vagaries of human emotion into hard data.

### BRIEF DESCRIPTION OF THE DRAWINGS

Examples are described in the following detailed description and illustrated in the accompanying drawings in which:

FIG. 1a is a schematic illustration of an example of architecture of a system for automated analysis of online social channels according to an example;

FIG. 1b is a schematic illustration of an example of architecture of a system for automated analysis of online social channels according to an example;

FIG. 2a is a schematic diagram of reports issued by a live customer intelligence system for automated analysis of online social channels, according to an example;

FIG. 2b is a schematic diagram of a user interface of a system for automated analysis of online social channels according to an example;

FIG. 3 is a schematic illustration of a geographical visualization of a data set according to an example;

FIG. 4 is a screenshot of a data input and acquisition page of an application for automated analysis of online social channels, according to an example; and,

FIG. 5 is a schematic illustration of a method for automated analysis of online social channels according to an example.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the methods and apparatus. However, it will be understood by those skilled in the art that the present methods and apparatus may be practiced without these specific details. In other instances, well-known methods, procedures, and components have not been described in detail so as not to obscure the present methods and apparatus.

Although the examples disclosed and discussed herein are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

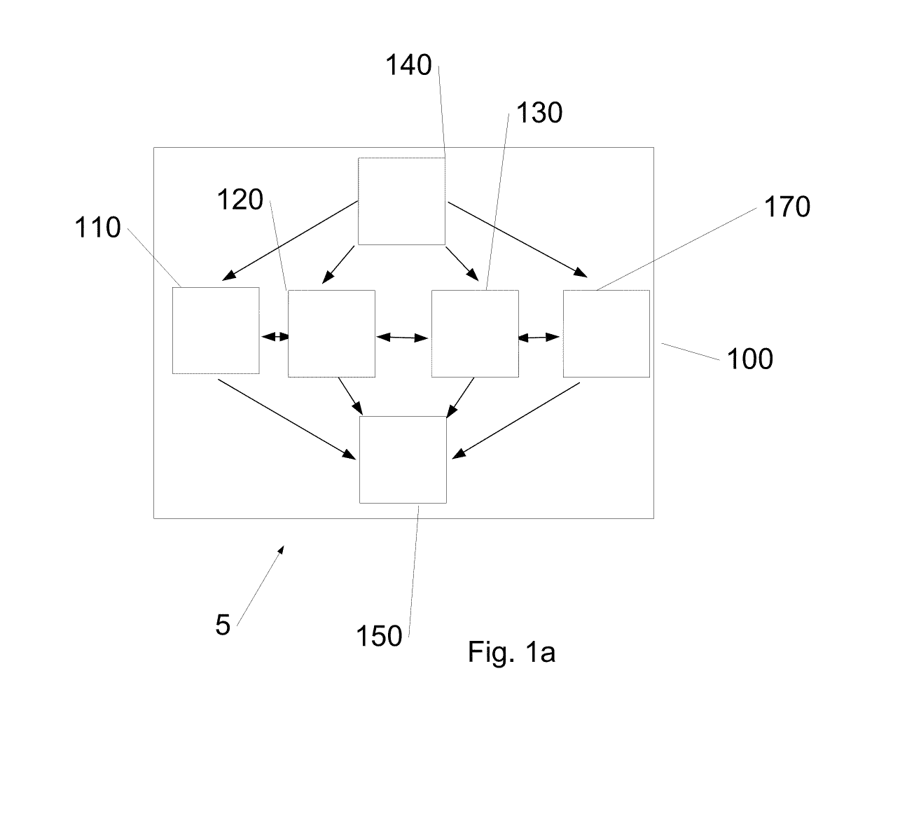

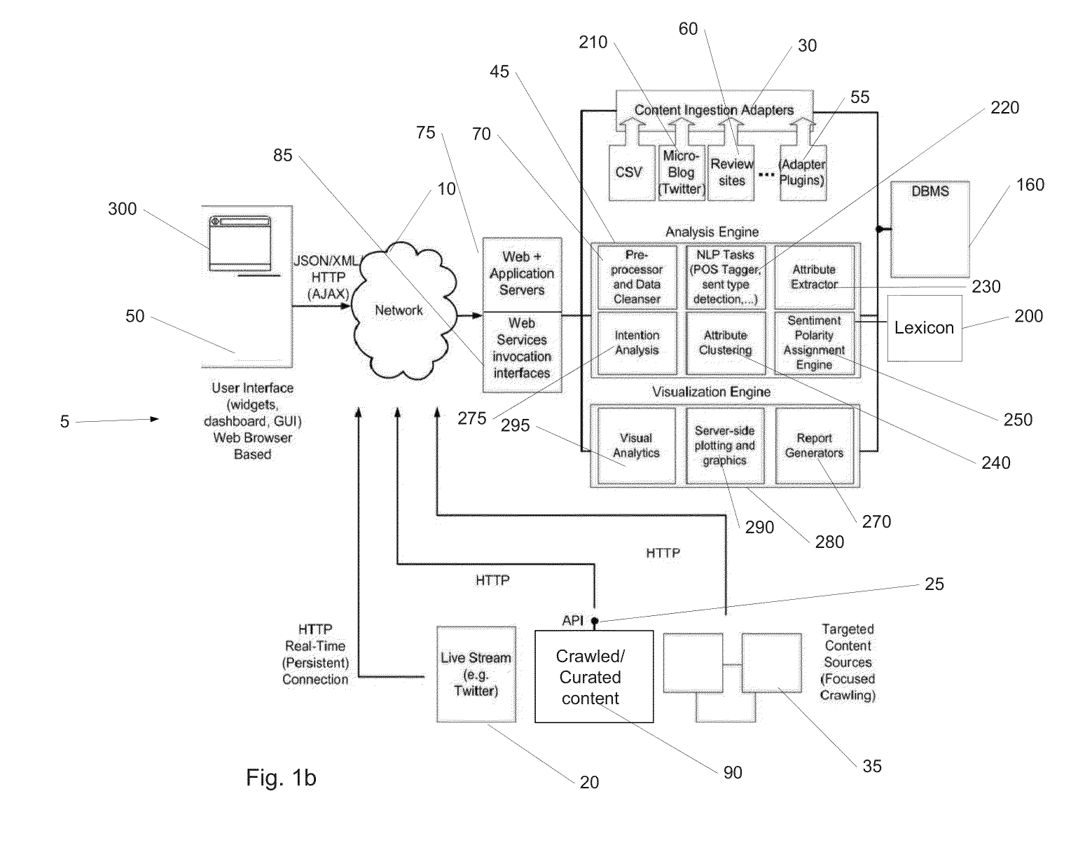

FIG. 1a is a schematic illustration of an example of architecture of a system 100 for automated analysis of online social channels which supports a cloud service with Representational state transfer (REST) interface, according to an example.

Typically, the architecture of a Social Media Analysis System (SMAS) 5 supports a cloud service with REST interface, the REST interface typically being a style of software architecture for distributed hypermedia systems such as the World Wide Web as known in the art.

SMAS 5 may include one or more processor(s) or controller(s) 110, memory 120, long term storage 130, input device(s) or area(s) 140, and output device(s) or area(s) 150. Input device(s) or area(s) 140 may be, for example, a touch screen, a keyboard, microphone, pointer device, or other device. Output device(s) or area(s) 150 may be, for example, a display, screen, audio device such as speaker or headphones, or other device. Input device(s) or area(s) 140 and output device(s) or area(s) 150 may be combined into, for example, a touch screen display and input which may be part of system 100.

System 100 may include one or more databases 170. Databases 170 may be stored all or partly in one or both of memory 120, long term storage 130, or another device.

Databases may be massively parallel databases, the massively parallel databases configured to store data and configured for fast ingestion and instantaneous, or in some examples, near instantaneous, or in some examples, typical speed responses to one or a plurality of queries from a user.

Processor or controller 110 may be, for example, a central processing unit (CPU), a chip or any suitable computing or computational device. Processor or controller 110 may include multiple processors, and may include general-purpose processors and/or dedicated processors such as graphics processing chips. Processor 110 may execute code or instructions, for example, stored in memory 120 or long-term storage 130, to carry out examples of the present invention.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include multiple memory units.

Long term storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit, and may include multiple or a combination of such units. In some examples, SMAS 5 may have several components functionally organized in three parts: data acquisition, analysis and visualization.

FIG. 1b is a schematic illustration of an example of architecture of a system for automated analysis of online social channels e.g., online sites, according to an example.

In some examples, SMAS 5 may acquire content, e.g., pull data, upload data, and/or stream data from multiple sources on the web, e.g., online sites. Typically, the content is acquired for eventual display of some or all of the content to one or a plurality of users.

In some examples, SMAS 5 may acquire content from websites, or online sites as a continuous stream of data. In some examples, SMAS 5 may acquire content from social media sites or channels. In some examples, data is collected in one or more batches representing a temporal snapshot of particular content in a website, e.g., the user or editor generated reviews in a retail websites or posts and comments on social networking webpages.

In some examples, the batches may reflect particular temporal time periods. In some examples, the batches may reflect many desired temporal time periods. In some examples, the batches may reflect SMAS 5 pulling all content, independent of a particular temporal time period, related to a particular product, or all comments on a particular social media web page.

Typically, content may be streamed to SMAS 5 and/or collected by SMAS 5 and stored within SMAS 5 to be analyzed.

Typically, content from microblogs may be streamed to SMAS 5. In some examples, content from other online social channels, such as social networking sites where content may be in constant flux, may be streamed to SMAS 5. In some examples, content from review sites and/or retail sites, or other websites, e.g., typically websites where the data may not be in a constant flux, may be pulled from the websites and uploaded to databases or memory modules within SMAS 5 for analysis.

The analysis may in some examples, include sentiment analysis via sentiment algorithms, in some examples, the analysis may include influence analysis conduced via influence algorithm, in some other examples, the analysis may include intention analysis via intention algorithms. In some examples, other types of analyses may be conducted by SMAS 5. In some examples, the analysis conducted by SMAS 5 may be a configured to be a black box to a user.

In some examples, SMAS 5 may conduct analyses on the entirety of the stored data within SMAS 5. In some examples, the data may be distilled to an attribute level prior to analysis. In some examples this data distilled to an attribute level may be analyzed in an attribute by attribute analysis.

In some examples, SMAS 5 may extract data from web content that has been crawled or curated 90. In some examples, the website may have an application programming interface (API) 25. In some examples, the website may not have an API. In some applications, SMAS 5 may extract data from targeted content sources 35

Typically, all ingested data, as well as analysis results, may be stored in an SMAS 5 database which may be queried by a visualization processor and a reporting generator upon a user's request. In some examples, a backend Analysis Engine 45 is composed of different modules, each one in charge of performing a specific task that either prepares the text for being analyzed, or analyzes it with natural language, text mining and/or statistical techniques. Typically, results of the analysis are pulled out of the database to be processed by visualization techniques as are known in the art which produce intuitive and dynamic visualizations which may in some examples dynamically change as new results are being produced.

SMAS 5 may typically conduct opinion mining and/or sentiment analysis and/or influence analyses and/or other analyses. In conducting opinion mining and/or sentiment analysis SMAS 5 may run one or a plurality of algorithms. Some of the algorithms run by SMAS 5 may be configured to extract the polarity of sentiments embedded in online content. In some examples, SMAS 5 may apply real-time data, typically real-time streaming data, without precluding its applicability to stored data.

In some examples, SMAS 5 may operate a number of analyses. In some examples, SMAS 5 may operate the analyses consecutively. In some examples, SMAS 5 may operate the analyses simultaneously, and/or in parallel.

In some examples, SMAS 5 may distill the content of the online social sites into attributes that are being recorded and/or discussed online.

In some examples, SMAS 5 may conduct an attribute analysis. Typically, in the analysis, SMAS 5, or a component thereof, may discern, e.g., from textual inputs, key attributes regarding the textual inputs, including entities, and aspects of entities discussed in the text.

The discerned attributes may be clustered by SMAS 5 or components thereof into semantic groups. In some examples, the semantic groups may form a taxonomy or hierarchy that facilitates navigation of the original texts, described above.

Typically, a frontend of SMAS 5, the frontend described as a dashboard below, may be configured to typically present data in real-time. In some examples, the frontend may present the data not in real-time.

In some examples, the frontend of SMAS 5 may allow the user to reorganize the hierarchy and/or to select the attributes that are interesting for visualization. In some examples, SMAS 5 may reorganize the hierarchy and also to select the attributes that are interesting for visualization automatically.

In some examples, textual attributes, described above, selected by default by SMAS 5, or a component thereof, may be those textual attributes with a highest frequency in the analyzed dataset.

In some examples, a tree visualization of an attribute hierarchy for a dataset may be constructed and viewed in a configurable graphical user interface, typically a user-configurable dashboard 300, the dashboard described below.

In some examples, SMAS 5, or a component thereof, may analyze the relative popularity of attributes, the attributes relating to the text, both described above, to discern whether the issue is popular online. In some examples, SMAS 5 may use visualizations within dashboard 300, such as an attribute cloud, described below, to provide opportunity for a user to find insight, and in some examples, a birds-eye view of the data. In some examples, SMAS 5 may use visualizations within dashboard 300, such as an attribute cloud, described below, to provide a view of the buzz about an entity or event.

In some examples, SMAS 5, or a component thereof, may conduct an influence analysis of inputted data, the data inputted either automatically or manually. Typically, the influence analysis provides the user with quantitative and qualitative information regarding the influential nature of an author of an online text, and/or in some examples, quantitative and qualitative information regarding the influential nature of content on social media forums.

Typically, SMAS 5, or a component thereof, may assign an influence score to the author of every inputted social media post.

In some examples, the number of viewers, commentators and replies to a particular inputted online text may be used to calculate a sentiment value. In some examples, the number of “followers” or “fans” (both direct and indirect) for each author of an online text may be used to calculate for example, an influence or sentiment value.

Typically, SMAS 5 may combine one or a plurality of dimensions of influence in an analysis with the other dimensions of data related to the online text or other inputted online texts. In some examples, the combination of one or a plurality of dimensions of influence in an analysis with the other dimensions of data related to the online text may provide a user with the ability to explore, detect, or otherwise analyze interesting patterns, such as the attributes mentioned by the most influential authors or the change in sentiment of the influential authors.

In some examples, SMAS 5 may automatically combine one or a plurality of dimensions of influence in an analysis with the other dimensions of data related to the online text to detect or otherwise analyze interesting patterns, such as the attributes mentioned by the most influential authors or the change in sentiment of the influential authors.

In some examples, SMAS 5 may conduct an Intention analysis. Typically, done with intention algorithms, the intention analysis may detect the intentions of an author or an online text.

Typically, data that can be employed to determine intentions of an author of an online text may be extracted from online forums, call center notes, or other forms of online and/or offline data.

In some examples, SMAS 5 may include an intention analysis unit 275. Typically, analysis unit 275 may use techniques based in natural language processing and text mining may be employed to extract different components of the data that can be used to determine and analyze the intentions of an author of an online text. These components may include an intention phrase (usually formed by verb and prepositions), an intention object (e.g., the noun or proper noun), and other attributes of the intention (e.g., intended date, party size, age range). Typically, once this information is extracted from the online text, it may be loaded automatically into a database component of SMAS 5 and made available for visualization, reporting and further analysis, as described below.

In some examples, a visualization may include a tag cloud, as described below for the intention objects. In some examples, the tag cloud may be constructed such that the user may be able to click on a term within the tag cloud to see the underlying online text that may contain the intentions.

In some examples, SMAS 5 may be configured to conduct a Sentiment analysis. Typically, a sentiment analysis may use different techniques in the art to analyze the sentiment of the attributes or aspects mentioned in an online text depending on characteristics of the text.

In some examples, a sentiment analysis may be conducted on a document collection, the document collection, in some examples, manually uploaded. In some examples, data may be uploaded through a dashboard, the dashboard described below, or automatically uploaded to a local SMAS 5 database 160. In some examples, sentiment analysis may be conducted in real-time over streaming data.

Typically, as documents are analyzed and the sentiment of each attribute occurrence extracted, the sentiment values may be stored in a database 160 within SMAS 5 to be available for visualization, reporting and/or further analysis.

Typically, SMAS 5 may handle real-time streams by streaming data to one or a plurality of databases, or memory modules configured to receive streaming data from the internet and/or other sources. Typically, once the data is in a memory module, computations may be performed without requiring any access to the underlying sources.

In some examples, analysis of streaming data may use continuous access to a source, the data incorporated into memory where the analysis computations may be applied.

In some examples, the data may be uploaded to databases, the databases configured for rapid responses to user queries and/or rapid acquisition of data some from online sites and other sources.

In some examples, SMAS 5 may determine the polarity of opinion words when this polarity is context-dependent. For example, the word “shazbot” which may be a negative opinion word in a typical opinion word lexicon, would be placed in a domain-specific positive opinion word lexicon during a previous off-line unsupervised learning phase. As another example of a context-dependent opinion word, the word—large may be a positive word for the size of a laptop screen, but may be considered a negative word when used to describe the size of the battery of said laptop.

SMAS 5 may also deal with noisy data sources like microblogs 210 wherein micro-blogging messages that often have grammatically incorrect English (or other language), non-standard language usage and/or may use emoticons, colloquial expressions, abbreviations, and other non-standard terminology and syntax.

Typically, SMAS 5 may also identify the polarity of non-standard or intentionally misspelled English words.

In some examples, SMAS 5 may also include one or a plurality of graphical user interfaces (GUI), the graphical user interface 50 may be configurable and/or dynamic in its nature, and may include charts that dynamically change as data streams in and is analyzed, to show how the sentiment on a set of selected topics is evolving over time. GUI 50 may be connected to other components of SMAS 5 via a network 10. GUI 50 may be the frontend described above.

I n some examples, GUI 50 may be connected to content, as well as visualization analysis engine 280, analysis engine 45, application servers 75, and/or web services invocations interfaces 85.

SMAS 5 may also, in some examples, allows the user to visually explore the sentiment scores, for example through GUI 50, to easily understand how they were computed, while at the same time getting insight into the emotions expressed about a given aspect or topic.

Typically, SMAS 5 may have a configurable dashboard 300, the dashboard may be one or a plurality of GUI 50 and may be the frontend described above. Typically dashboard 300 may allow the user to specify the streaming data, or static data source for analysis.

Typically, dashboard 300 may include one or a plurality of graphical user interfaces 50. Typically, one or a plurality of the graphical user interfaces 50, or in some examples, the entire dashboard 300 may be configurable, extensible and/or dynamic.

In some examples, dashboard 300 may be configured to present the data as a snapshot of a temporal moment. In some examples, dashboard 300 may be configured to present the data in real-time. In some examples, dashboard 300 may be configured to present data as both a snapshot of a particular time period, and then in some examples, reversibly switch to real time. In some examples, dashboard 300 may be configured present the data in real time then, in some examples, reversibly switch to present data as a snapshot of a particular time period.

In some examples, dashboard 300 is configured to present the data as a snapshot only, for example, when data is crawled and extracted, e.g., from a site containing user generated reviews.

In some examples, data presented by one or a plurality of interfaces may be presented such that the underlying computations and/or analysis are implied. In some examples, the underlying computations may be implied via color coding some or all of the presented data in dashboard 300, the color coding reflecting the analysis. In some examples, computations may be implied by different sizes of text, graphics charts, widgets and other methods of implying underlying computations.

Typically, dashboard 300 allows the user specify a source. In some examples, the source may be a streaming source such as a microblog. In some examples, the source may not be streaming and may be a review site, and/or a retail site with reviews and/or a social networking site. In some examples, the source may be an uploaded file with preloaded content.

Typically, for an on-line site a specific adaptor may be required, the adapter configured to interface with the website such that desired content is extracted from the site at desired intervals and, in some examples, in a desired format. In some examples, the adapters may be scrapers, extractors, spiders, bots or other methods for extracting data from websites. In some examples, the adaptors may be designed for a particular website. In some examples, the adaptors may be designed for general use. In some examples, the adaptors may common software tools as are known.

In some examples, SMAS 5 may have a configurable dashboard 300 that allows the user specify the topic(s) to monitor and optionally other parameters such as the time window size to display on the charts, the refresh rate and the aggregation period (e.g., aggregate the sentiment of the last hour) if the default values are not suitable.

In some examples, dashboard 300 may be temporal-view adjustable. For example, visualization features of dashboard 300 may be dynamic allowing the user to move backwards, forwards in time, and/or pause in time

In some examples, dashboard 300 may be pausable and/or replayable. For example, dashboard 300 may enable the user to pause the visualization of the sentiment monitoring session and save it to replay (on the dynamic charts) and explore it later. In some examples, the monitoring continues, i.e., data continues streaming in, analysis keeps going on, data and the results may continue to be stored by SMAS 5, the results may be available for viewing later.

In some examples, dashboard 300 may be configured to temporarily pause the data from being uploaded to dashboard 300, the dashboard then reflecting a time period up to a temporal moment. In some examples, this pausing may make the visualization charts, and/or the dynamic charts, described below, static. For example, if a user determines an interesting development, the user will have the ability to freeze that moment in time and analyze what the user sees in dashboard 300.

Typically, the monitoring and/or analysis conducted by SMAS 5 may continue while dashboard is paused. In some examples, the user may have the ability to resume the dynamic nature of the charts, the charts described below. In some examples, the user may have the ability to pause dashboard 300 by pressing or clicking on an on-screen pause button, or another form of input such as a keyboard or mouse.

In some examples, the user may have the ability to un-pause dashboard 300 by clicking on, or pressing an on screen play button. In some examples, others forms of input such as a keyboard or mouse may be used to interface with the dashboard and to push the play button.

In some examples, the user will be able to move along a timeline of data, the timeline of data may be presented graphically on dashboard 300, as described below to play or replay a temporal moment or to move to a particular temporal moment.

In some examples, SMAS 5 may be configured to operate over real-time streaming data sources 20, including in some examples, micro-blogging sites, frequently updated content sources, including review sites, historical/stored content including previously crawled data, and other sources as known in the art.

Typically, web-service endpoints of SMAS 5 support both traditional, e.g., desktop and other traditional modes known in the art, e.g., browser-based clients, as well as mobile devices. In some examples, content negotiation between a server, the server may be a component of SMAS 5, and client may be used, to have the same web service deliver different versions of the analysis results and content.

In some examples, content ingestion adapters 30, in some examples APIs, as described above. pull data from different source types, including review sites 60 which have differing schema and characteristics, into SMAS 5. In some examples, plug-in adapters 55 may allow for accommodation of new data sources. Data obtained as a result of the content ingestion through the adapters may typically be fed to the analysis engine 45 to be processed by a sentiment processor, or another processor for example, the intention processor.

Typically, the sentiment processor consists of modules that implement composable operators for the different steps of a sentiment analysis. In some examples, this approach gains flexibility for including new operators that respond to the requirements imposed by different types of data sources. For example, extracting opinions from microblogs 210 may typically require different techniques in some steps of the analysis than for extracting data from reviews, the reviews typically user or editor generated on retail web sites.

SMAS 5 typically uses a method to perform sentiment analysis on microblogs which may be a combination of lexicon-based and machine-learning sentiment analysis methods, as are known in the art. In some examples, a lexicon-based method may be first applied to make opinion polarity assignments on attributes or entities in microblogs. In a following step, an opinion polarity classifier in analysis engine 45 (e.g. SVM classifier, or other classifiers known in the art) may be trained based on the result of the lexicon-based method. Trained opinion polarity classifier in analysis engine 45 may used to perform opinion assignment on attributes or entities on new micro blogs which cannot be determined by the lexicon-based method.

Typically, SMAS 5 may also include a Pre-Processor and Data Cleanser 70. This module may, in some examples, pre-process and clean data, the pre-processing and cleaning configured to make collected data amenable for analysis by further stages of an SMAS pipeline.

In some examples, Pre-Processor and Data Cleanser 70 may removes spam microblogs and duplicates microblogs that may skew analysis results. In some examples, Pre-Processor and Data Cleanser 70 may restore popular abbreviations, syntax changes and other novel word usage as known in the art to their corresponding original forms.

In some examples, a micro-blogger who publishes the same microblog messages all the time (e.g. the same content and the same structure), may be considered a spammer by Pre-Processor and Data Cleanser 70, and all their microblogs may be removed from a curated data set 90. In some examples, microblogs that are mostly in uppercase notation are usually determined to be spam so they are removed from the data set as well.

In some examples, duplicate microblogs that typically do not provide useful information for analysis are also removed from the data set 90 to prevent duplicates.

In some examples, abbreviations and misspellings may be frequently used in microblogs, as are known in the art. In some examples, SMAS 5 may include a normalization dictionary semi-automatically compiled 200 using some distance metric such as Levenshtein distance. This normalization dictionary may be used to restore popular abbreviations to their corresponding original forms.

Typically, the normalization dictionary is generated automatically by detecting variations of a same word in the content extracted from online sources and other sources. In some examples, the user may need to manually review the results of the normalization dictionary and discard those phrases/words (including abbreviations) that are not variations of a given word and some times even to insert additional entries.

In some examples, the normalization dictionary may be used by SMAS 5 for an analysis where it may be necessary to unify all variations of a same attribute. In some examples, SMAS 5 may also use an opinion lexicon, a white-list and/or stop words list, all of these lists are typically internally used by the SMAS 5 analysis.

SMAS 5 may further be configured to remove specific elements from data. In some examples, specific elements may include external links and user names, as are known in the art and, in some examples, of microblogging may be signified by @. Typically, non grammatical punctuation is kept since people often express sentiment with emoticons, as are known in the art.

SMAS 5 may also include an NLP Task module 220. An NLP Task module 220 may perform several natural language processing tasks required by the other stages of the SMAS pipeline, including the typical tasks of decomposing text into sentences, splitting sentences into appropriate tokens, and tagging them with their part-of-speech. Typically, applying sentence detection algorithms may decompose a microblog 210 message into its component sentences.

SMAS 5 may also include an Attribute Extractor 230. Typically, online opinions are expressed not just on entities, but at a finer granularity on attributes of entities. An Attribute extractor 230 may be configured to discover the attributes of entities mentioned in an online text such as microblogs. SMAS 5 may use noun as attributes in addition to other word-forms.

SMAS 5 may also include an attribute clustering module 240. Attribute clustering module 240 may be configured to navigate, interpret and consume extracted attributes described above.

In some examples, attribute clustering module 240 may employ a number of techniques to first clean, normalize and then cluster the discovered attributes into semantically cohesive categories by using unsupervised machine learning. Typically, emergent attributes may be observed to be noisy, replete with misspellings, and variations in morphology.

In some examples, clustering algorithms may use lexical databases to compute semantic distance between attributes, based on their relative distances in hypernym/hyponym trees, to cluster the attributes into cohesive categories. In some examples, the WordNet database may be used.

Typically, once a semantic relationship is established, a clustering algorithms such as K-means may be applied to obtain groups of attributes with common relationships corresponding to domain categories, e.g., a service category in a hotel review.

In some examples, domain-specific attributes may not be found in standard lexicons, community-curated knowledge bases, e.g., FreeBase, may also be used.

SMAS 5 may also include a Sentiment Polarity Assignment Engine 250. Sentiment Polarity Assignment Engine 250 may assign sentiment polarity to the attributes discovered in a sentence by using one or a plurality of approaches. These approaches may include a lexicon-based approach, wherein the lexicon-based approach uses one or a plurality of lexicon to obtain the polarity of opinion words and expressions, as described above.

Typically, polarity of opinion words and expressions may be used to compute the sentiment of related previously identified attributes.

In some examples, sentiment polarity assignment engine 250 may assign sentiment polarity via a classifier-based approach. Typically, the classifier-based approach may be a machine-learning based approach that may be usable when the lexicon-based approach may not be able to determine the polarity of attributes and entities due to the presence of emoticons and/or colloquial words in the sentences.

In some examples, a hybrid approach where the lexicon-based approach analyses some sentences and the classifier-based one analyzes others may be employed.

SMAS 5 may also include a Context-Dependent Lexicon Builder. The Context-Dependent Lexicon Builder may be a component of lexicon 200. The context-dependent lexicon builder may be employed to build an opinion lexicon by identifying the correct polarity of opinion words according to the attribute in the given domain.

The Opinion lexicon, described above, may be used to aid in the computing of the sentiment of attributes.

In some examples, the lexicon may be built manually. In some examples, SMAS 5 may automatically build a lexicon using an optimization-based approach as known in the art.

SMAS 5 may also provide for the discovery of geographical patterns in the data. In some examples, data sources that include location information, can be analyzed, typically through geo plots to detect geographical patterns. In some examples, geographical data may be combined with other dimensions such as time or sentiment through the various filters.

In some examples, SMAS 5 may provide other filters, the filters configured to filter by criteria. In some examples, the criteria may include source, geography, time, topics, attributes, or any other metadata associated to the data. In some examples, SMAS 5 may be configured to display, typically via the graphical user interface, only a portion of the analyzed dataset that is of interest at a given moment.

SMAS 5 may provide for reporting options, and may generate one or a plurality of reports via a report generator 270, the report generator part of a visualization engine 280 that converts the analyzed data into a format that may be used by a user. The visualization engine 280 may also include other components. Other components may include a plot generator 290 for generating server-side plots and graphics, and a visual analytics unit 295.

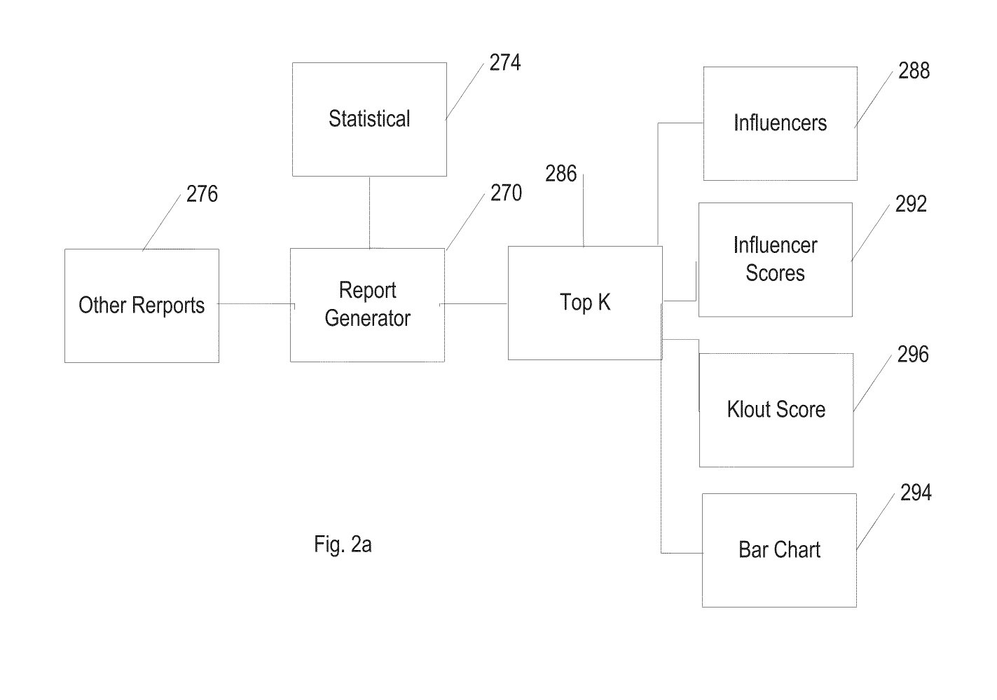

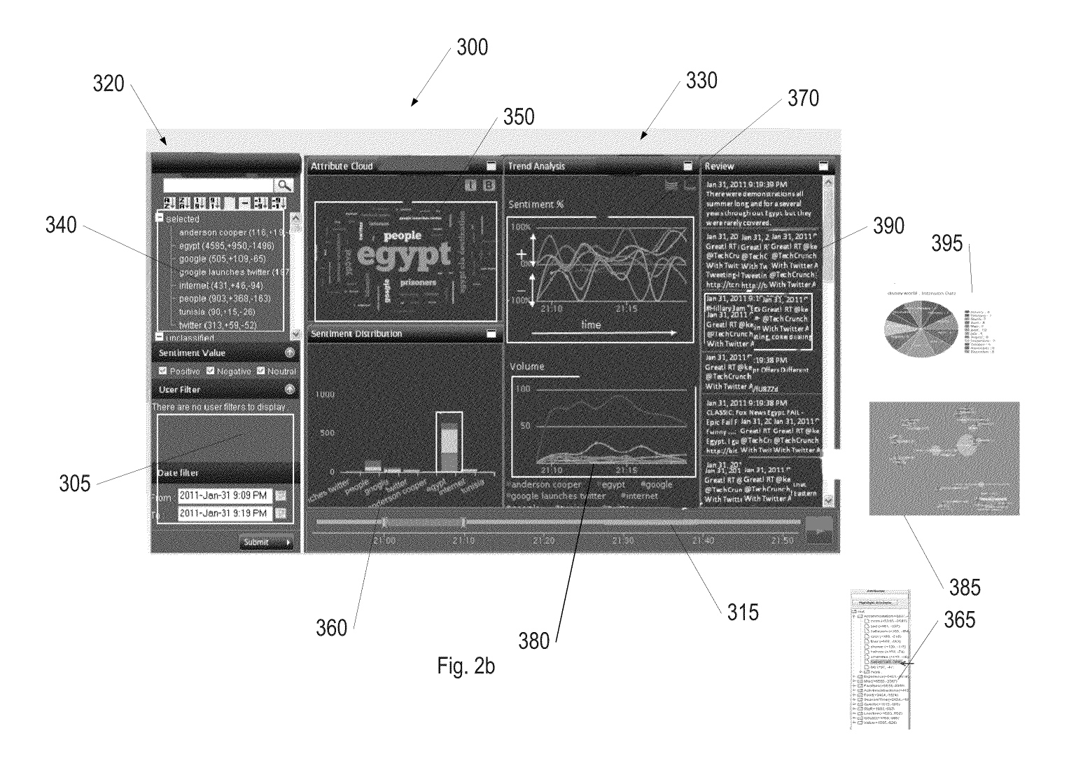

FIG. 2a is a schematic diagram of reports issued by the live customer intelligence system.

SMAS 5 may provide for reporting options, and may generate one or a plurality of reports via a report generator 270. In some examples, summary reports 272 may be generated by SMAS 5, summary reports 272 may include statistical charts 274, and in some examples, other charts 276 regarding the analysis conducted by SMAS 5.

In some examples, a top K family report 286 may be generated. Typically, top K family report may include the results of the influence analysis, described above, on microblogging. In some examples, top K family report may include data detailing top influencers 288, scores associated with top influences and their top microblogs. Typically, top influencer report 292 present two or more parameters including a dataset name and the upper limit on the number of results to display: Typically, the top K family report may be represented as a bar chart 294 that displays the microblog authors with the highest influence (Klout) score 296, the Klout scores as are known in the art. In some examples, an x-axis on the bar chart may contain the names of the top influencers and a y-axis may contain their Klout scores 296.

In some examples, Klout scores may be obtained through a Klout service, as known in the art. In some examples, other algorithms, including art influence scoring algorithms may be used.

FIG. 2b is a schematic diagram of a user interface.

In some examples, a user may interact with SMAS 5 via a web-based dashboard 300. Typically, web-based dashboard 300 may provide one or a plurality of visual representations of the results of an analysis conducted by SMAS or a portion thereof

In some examples, dashboard 300 may be configured to perform a specific kind of analysis on a given source, e.g., to monitor the sentiment of the attributes of a movie in the microblogging streams, or to analyze the intentions in the comments of an online forum.

In some examples, a user may also select what to visualize within dashboard 300. In some examples, the user may choose which attributes to visualize from a list of discovered attributes. In some examples, typically for time-stamped content, a time slider 310 may let the user select a particular visualization period to zoom-in and out along a time dimension. Typically, once the dashboard has been configured, the results of an analysis are visualized on different panels 320 of dashboard 300. In some examples, the data may be presented in different panels, with the objects in the different panels typically representing different paradigms of data visualization. Different paradigms of data presentation may include word clouds, graphs, charts, and other paradigms of data presentation. In some examples, colors and filters may be used to present the data.

Typically, panels may include charts 330 that may dynamically change as new data is analyzed.

Typically, dashboard 300 has a time slider 315. Time slider 315 is typically configured to narrow or expand the view to the desired period of time or to provide an adjustable temporal view ad described above.

In some examples, elements of the dashboard may include an attribute tree 340, an attribute cloud 350, sentiment distribution bar charts 360, sentiment trend data 370, and incoming microblogs 390. Typically, all of these elements, and or additional elements, may be updated in real-time as new data arrives and is analyzed.

In some examples, buzz /volume trend data 380 and/or one or a plurality of pie charts 395 may be employed by dashboard 300, illustrated on the side of dashboard 300 for illustrative purposes only. Typically, buzz /volume trend data 380 and/or one or a plurality of pie charts 395 may be displayed on dashboard 300.

Typically, the pie charts may be configured to display information. The information may contain a distribution of values for attributes, and in some examples, intentions on that object data, as described above.

In some examples, dashboard 300 may provide different interactive visualizations that may show the relationship between intention phrases, intention objects, and intention attributes, as described above, discovered from the textual content and derived from an online text, the online text extracted and parsed either automatically by SMAS 5 or a component thereof, or via a user.

In some examples, dashboard 300 may have bubble plots 385. Bubble plots 385 may be employed by dashboard 300, illustrated on the side of dashboard 300 for illustrative purposes only. Typically, bubble plots 385 may be displayed on dashboard 300, typically, in lieu of other charts or elements of dashboard 300, described above. Typically, as the user clicks on a bubble, the bubble expands to show children bubbles.

In some examples, bubble plots 385 may be employed by dashboard 300, for visualization of intention analysis as well as for visualization of influence analysis. These bubble plots may in some examples, let the user fold and unfold each bubble to display or hide its connections.

In some examples, dashboard 300 may display data relating to sentiments, as described below. Typically, a sentiment extracted from an online text or other source of data may be visualized in an attribute cloud 350.

Typically, an attribute cloud may be configured such that the color of the attributes reflects the average aggregated sentiment. In some examples, the greener the displayed data, the more positive is this average sentiment; the redder, the more negative. In some examples, other colors may be used.

In some examples, yellow displayed data may reflect a similar number of positive and negative sentiments, and in some examples, data displayed in gray may reflect neutral sentiments.

In some examples, dashboard 300 may display sentiment frequencies on an attribute tree 365. Where each attribute is associated with two values preceded with a “+” and “−”sign respectively. Typically, attribute tree 365, may be similar to tree 340. In some examples, attribute tree 365 may differ from tree 340 in that whereas attribute tree 365 typically includes categories for the attributes and typically allows for each category to be unfolded to see the attributes within each category of attributes, tree 340 typically has attributes, wherein the attributes are not categorized. Typically, attribute tree 365 may be employed by dashboard 300, illustrated on the side of dashboard 300 for illustrative purposes only. Typically, attribute tree 365 may be displayed on dashboard 300, typically, in lieu of other charts or elements of dashboard 300, in some examples, tree 340, as described above.

In some examples, trees 340 and 365 provide the user with the ability to select the attributes which will be reflected in the analysis displayed on the dashboard charts, the charts described above. Typically, the user can select and unselect attributes during a visualization session.

In some examples, sentiment data, described above may be visualized on dashboard 300 with a graph, e.g., sentiment distribution bar charts 360. In some examples, the graph may display the sentiment trend of a set of attributes where there is one line per attribute. In some examples, the lines may change dynamically as new content is analyzed and a sentiment trend evolves.

Typically, sentiment distribution bar charts 360 may show the proportion of positives, negatives and neutral sentiments for the attributes selected by the user. This may be different than the sentiment trend chart 370 which may show the evolution in the sentiment of the selected attributes.

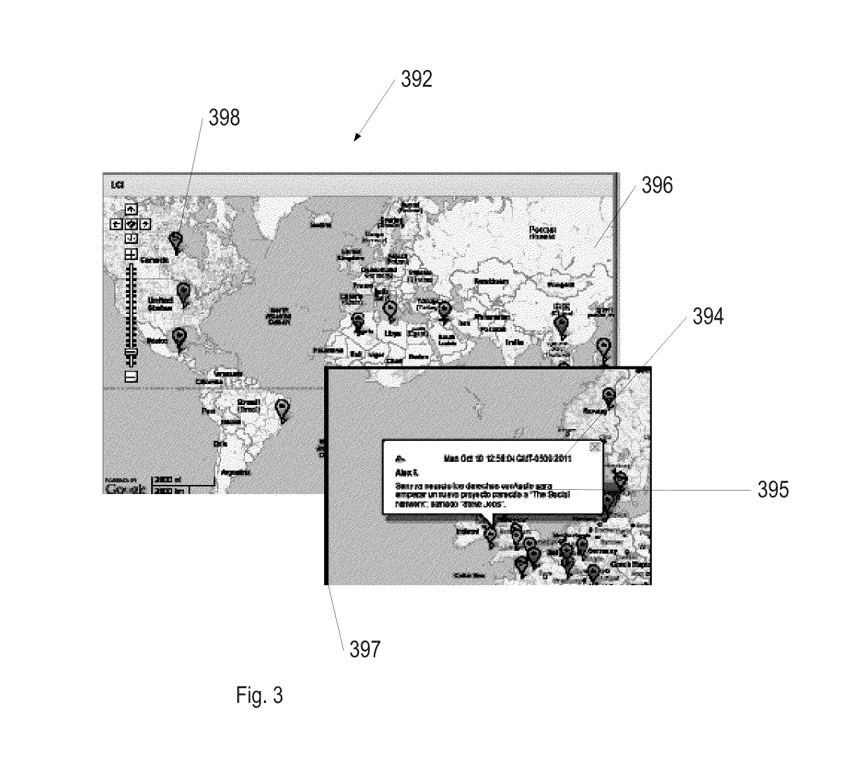

FIG. 3 is a schematic illustration of a geographical visualization of a data set.

SMAS 5 may also provide for the discovery of geographical patterns in the data. In some examples, data sources that include location information can be analyzed, typically through geo plots 392 to detect geographical patterns. In some examples, geographical data may be combined with other dimensions 394 such as time or sentiment through the various filters.

In some examples, SMAS 5 may be able to deduce which regions of the country a particular topic is most frequently mentioned as opposed to others, and whether it is mentioned with positive, negative or neutral sentiment.

SMAS 5 may provide a geographic map 396 and the locations where pieces of input (such as social media posts) originated from noted by markers 398. Typically, each marker 398 on the map may be colored to indicate whether the post is associated with positive, negative, mixed or neutral sentiment 395. In some examples, for places on the map that may have numerous data points, the geographical visualization may display aggregate markers. In some examples, the geographical visualization may provide the user with an ability to drill-down to view each individual post in a more focused window 397.

SMAS 5 may further provide for the determination and analysis of temporal patterns in the data. The determination and analysis of temporal patterns in the data may include sentiment trends over time, for example, in charts 370 and 380, a determination as to which attributes gain popularity, or if the change in sentiment or frequency of attributes is anomalous, based on the characteristics of historical data.

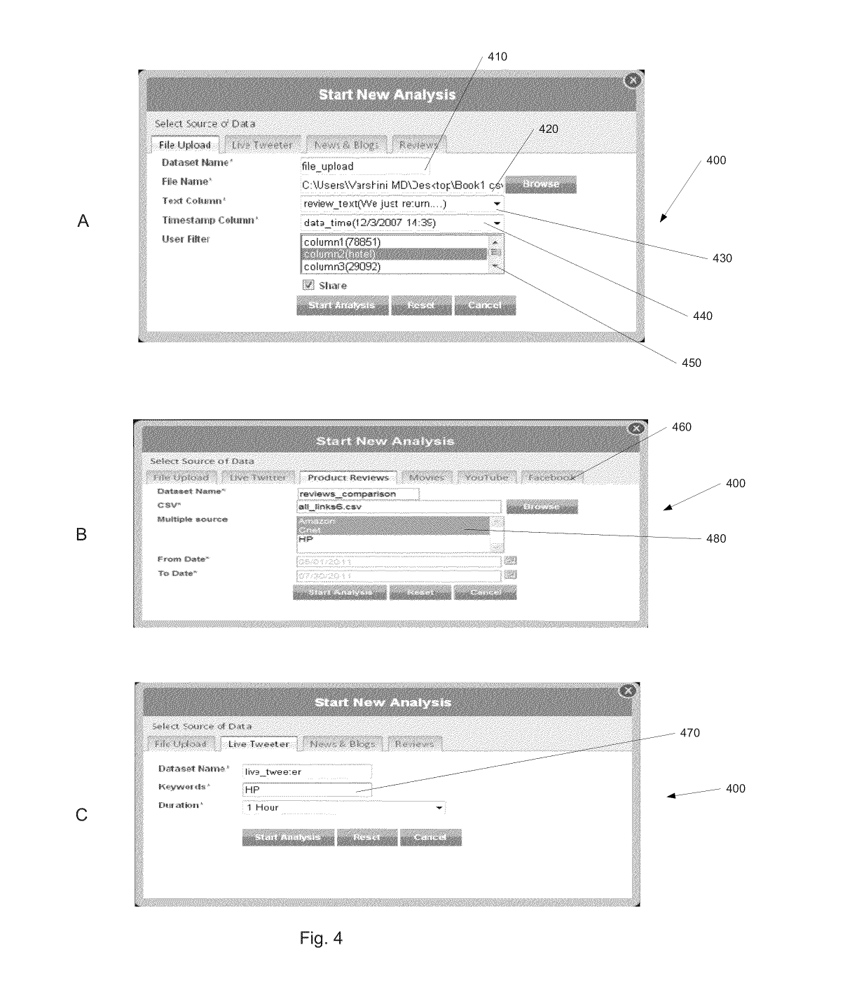

FIG. 4 is a screenshot of a data input and acquisition page.

A source selection box 400 may be part of a graphical user interface, providing the user with the ability to interact with SMAS 5, typically employed to upload a file. The source selection box 400 may include a plurality of parts. Parts, A, B and C are illustrated herein for illustration purposes only.

Typically, part A of source selection box 400 may be configured for file uploads to SMAS 5.

Typically, parts B of source selection box 400 may be configured to upload content from online websites such as review sites, to SMAS 5.

Typically, part C of source selection box 400 may be configured to interface with microblogs and/or social network sites, or other sites with content in flux, as described above, for streaming upload of content SMAS 5.

For file upload typically a user may provide information into a number of fillable windows including dataset name window 410, a file name to be uploaded window 420, Text column window 430, Timestamp column window 440 and user filter 450. In some examples, file name to be uploaded window 420 is brows able. In some examples, some of the windows may have drop down choices.

In some examples, a user may input data files with a custom format. In some examples, data with a custom format may include a file with the comments of a customer survey, enterprise support forum, call center notes, and other annotations.

In some examples, the user may specify the mapping between custom fillable fields within the upload box 400 and the fields that may be more essential for an analysis. In addition, the user can also specify other fields that can be used later to filter the results that will be displayed on dashboard 300.

In some examples, feeds may also be imported into SMAS 5, the feeds typically represented as tabs 460 on the top of the window. Typically, a data acquisition module, the module visually depicted via upload box 400, show in FIG. 4 as upload box B, allows for incorporation of content from real-time feeds. For example, microblogging services. Typically, a user may choose a data source, and specifies the query with keywords and Boolean operators, the keywords and Boolean operators typically inputted into keywords and Boolean operators window 470. In the case of a microblogs, keywords and Boolean operators may be used to input when the blogs are created. Microblog posts that satisfy the query are incorporated into the system in real-time. In some examples, window 470 is configured to be used to filter content streaming from an already selected source, and to select those microblogs from the source that are desired in real-time, as they are posted.

In some examples. SMAS 5 may extract content from multiple sources on the web, as depicted by upload box 400, B. In some examples, SMAS may extract data from content, e.g., as shown in multiple sources window 480, that has been crawled, as described above. In some examples, the website may have an Application programming interface (API), e.g., the source depicted in upload box 400, C, the API described above. In some examples, the website may not have an API. In some applications, SMAS may extract data from targeted content sources, as described above. Typically, the targeted data sources are those sources that require adaptors, extractors and/or scrapers.

In some examples, websites such as retail review sites which do not have APIs, e.g., the sources depicted in upload box 400 B. In some examples, data may nevertheless be incorporated into SMAS 5 via software solutions such as extractors and scrapers. Extractors may also employ solutions with sites that have APIs to extract the required content.

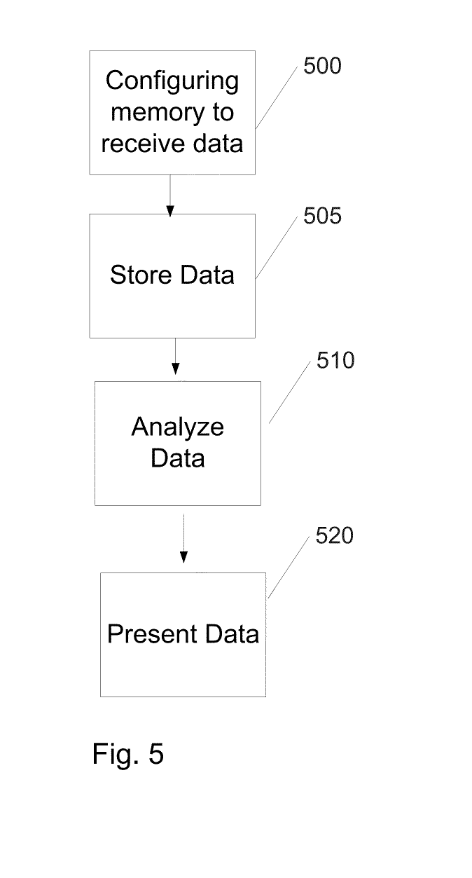

FIG. 5 is a schematic illustration of a method according to an example Typically, SMAS is configured to acquire data from one or more of the online social channels, e.g., social media and social media website, typically via designed or off the shelf adaptors, the adapters configured to acquire data as a snapshot or a continuous stream from one or more online sites, as depicted in box 500.

SMAS 5 may store the data acquired in a database, the database configured for rapid acquisition of data and typically, rapid responses to queries form one or a plurality of users, as depicted in block 505.

SMAS is then typically configured to analyze the data using a plurality of algorithms, the algorithms described above and as depicted in box 510. The algorithms maybe configured to distill insight at an attribute level.

SMAS 5 is typically configured to use one or a plurality of graphical user interfaces including in some examples, different kinds of visualization widgets to present, on a configurable and in some examples, extensible dashboard, one or more results of the plurality of algorithms, the results depicted through one or a plurality of paradigms of data visualization. In some examples, dashboard 300 may be further configured to be temporal-view adjustable, as depicted in box 520.

Examples of the present invention may include apparatuses for performing the operations described herein. Such apparatuses may be specially constructed for the desired purposes, or may comprise computers or processors selectively activated or reconfigured by a computer program stored in the computers. Such computer programs may be stored in a computer-readable or processor-readable non-transitory storage medium, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions. It will be appreciated that a variety of programming languages may be used to implement the teachings of the invention as described herein. Examples of the invention may include an article such as a non-transitory computer or processor readable non-transitory storage medium, such as for example, a memory, a disk drive, or a USB flash memory encoding, including or storing instructions, e.g., computer-executable instructions, which when executed by a processor or controller, cause the processor or controller to carry out methods disclosed herein. The instructions may cause the processor or controller to execute processes that carry out methods disclosed herein.

Different examples are disclosed herein. Features of certain examples may be combined with features of other examples; thus, certain examples may be combinations of features of multiple examples. The foregoing description of the examples of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A system for analyzing social media, the system comprising a processor to:
acquire data as a snapshot or a continuous stream from one or more online sites via adapters;
store the data in a database, the database configured for rapid acquisition of data and rapid responses to queries from one or a plurality of users;
analyze the data using one or a plurality of algorithms, the algorithms configured to distill insight at an attribute level; and,
present one or a plurality of graphical user interfaces on a user-configurable, and temporal-view adjustable dashboard, the dashboard configured to present one or more results of said one or a plurality of algorithms, said one or more results depicted through one or a plurality of paradigms of data visualization.

2. The system of claim 1, wherein the algorithms include sentiment and intention analysis algorithms.

3. The system of claim 1, wherein the configurable graphical user interface allows the user to select a source of data.

4. The system of claim 1, wherein the configurable graphical user interface is dynamic and is pausable and replayable to one or a plurality of time periods covered by the data.

5. The system of claim 1, wherein the system analyzes and presents the data and results in real-time.

6. The system of claim 1, wherein the dashboard presents a portion of the analyzed dataset, the analyzed dataset filtered by criteria, the criteria selected from a group including: data source, geography, time, topics, attributes, and other metadata associated with the data.

7. The system of claim 1, wherein presented data on the dashboard implies underlying computations.

8. A method for analyzing social media, the method comprising:
configuring adaptors to acquire data as a snapshot or a continuous stream from one or more of the online sites;
storing data in a database, the database configured for rapid acquisition and rapid responses to queries from one or a plurality of users
analyzing data using one or a plurality of algorithms, the algorithms configured to distill insight at an attribute level; and,
configuring one or a plurality of graphical user interfaces to present, on a configurable and temporal-view adjustable dashboard, the dashboard configured to present one or a plurality of results of said one or a plurality of algorithms, said one or more results depicted through one or a plurality of paradigms of data visualization.

9. The method of claim 8, wherein the algorithms for analyzing the data include sentiment algorithms and intention algorithms.

10. The method of claim 8, wherein the graphical user interface is dynamic.

11. The method of claim 8, wherein the dashboard presents the data as real-time data.

12. The method of claim 8, wherein the dashboard presents the data as a temporal snapshot.

13. The method of claim 8, wherein the dashboard presents a portion of the analyzed dataset, the analyzed dataset filtered by criteria, the criteria selected from a group including source, geography, time, topics, attributes, and other metadata associated with the data.

14. The method of claim 8, wherein the data is presented on the dashboard to imply underlying computations.

15. A non-transitory computer readable medium comprising instructions, which when executed cause a processor to:
acquire data as a snapshot or a continuous stream via one or a plurality of adapters.
store data in a database, the database configured for rapid acquisition and rapid responses to queries from one or a plurality of users
analyze data using one or a plurality of algorithms, the algorithms configured to distill insight at an attribute level; and,
configure one or a plurality of graphical user interfaces to present, on a configurable and temporal-view adjustable dashboard, the dashboard configured to present one or a plurality of results of said one or a plurality of algorithms, said one or more results depicted through one or a plurality of paradigms of data visualization.

16. The non-transitory computer readable medium comprising instructions of claim 15, wherein the algorithms for analyzing the data include sentiment and intention algorithms.

17. The non-transitory computer readable medium comprising instructions of claim 15, wherein the graphical user interface is dynamic.

18. The non-transitory computer readable medium comprising instructions of claim 15, wherein the dashboard presents the data as real-time data.

19. The non-transitory computer readable medium comprising instructions of claim 15, wherein the dashboard presents a portion of the analyzed dataset, the analyzed dataset filtered by criteria, the criteria selected from a group including source, geography, time, topics, attributes, and other metadata associated with the data .

20. The non-transitory computer readable medium comprising instructions of claim 15, wherein the data is presented on the dashboard to imply underlying computations.
